(19) United States
(12) Patent Application Publication
(10) Pub. No.: US 2025/0312756 A1
(43) Pub. Date: Oct. 9, 2025

(54) HYDROGEN GENERATION APPARATUS AND REACTION CASE

(71) Applicant: CANON KABUSHIKI KAISHA, Tokyo (JP)

(72) Inventors: TSUYOSHI KUROKI, Kanagawa (JP); SHOKO FUJIWARA, Ibaraki (JP); AKIKO TOMINAGA, Kanagawa (JP); KEIJI KARUBE, Ibaraki (JP); KENJI UTSUNOMIYA, Tokyo (JP); SHUNSUKE TSUDA, Tokyo (JP)

(21) Appl. No.: 19/240,984

(22) Filed: Jun. 17, 2025

Related U.S. Application Data
(63) Continuation of application No. PCT/JP2023/044539, filed on Dec. 13, 2023.

(30) Foreign Application Priority Data
Dec. 20, 2022 (JP) 2022-203048

(51) Int. Cl. B01J 8/02; C01B 3/06

(52) U.S. Cl. CPC B01J 8/0271; C01B 3/065; B01J 2208/00132; B01J 2208/00893; B01J 2208/028

(57) ABSTRACT

A hydrogen generation apparatus includes a case portion, a hydrogen carrier supply portion, a screw conveyor, a liquid supply portion, and a hydrogen collection portion. The hydrogen carrier supply portion supplies a solid hydrogen carrier to the case portion. The screw conveyor is disposed in the case portion, and includes a spiral blade for conveying the hydrogen carrier supplied from the hydrogen carrier supply portion. The liquid supply portion supplies a liquid containing water to the hydrogen carrier conveyed by the screw conveyor. The hydrogen collection portion collects hydrogen generated by a reaction between the hydrogen carrier and the liquid on the screw conveyor.

### CROSS-REFERENCE TO RELATED APPLICATIONS

This application is a Continuation of International Patent Application No. PCT/JP2023/044539, filed Dec. 13, 2023, which claims the benefit of Japanese Patent Application No. 2022-203048, filed Dec. 20, 2022, both of which are hereby incorporated by reference herein in their entirety.

### BACKGROUND

### Field of the Technology

The present disclosure relates to a hydrogen generation apparatus that generates hydrogen by using, as a raw material, a hydrogen carrier having a nature of generating hydrogen when a water-containing liquid is poured thereon, and to a reaction case that reacts the liquid with the hydrogen carrier.

### Description of the Related Art

As a hydrogen generation apparatus, an apparatus that supplies water and a solvent to sodium borohydride and generates hydrogen by hydrolysis of the sodium borohydride is proposed (for example, Patent Literature 1).

### CITATION LIST

### Patent Literature

Patent Literature 1: Japanese Patent Application Laid-Open No. 2017-114708

### SUMMARY

Here, a configuration of stably progressing a hydrolysis reaction of a hydrogen carrier such as sodium borohydride is desired for a hydrogen generation apparatus. Patent Literature 1 described above only describes generating hydrogen by supplying sodium borohydride, water, and solvent to a reaction portion, and does not describe how the reaction of sodium borohydride is specifically promoted in the reaction portion.

The present disclosure provides a hydrogen generation apparatus that easily promotes a reaction between a hydrogen carrier and a water-containing liquid.

According to a first aspect of the present disclosure, a hydrogen generation apparatus includes a case portion, a hydrogen carrier supply portion configured to supply a solid hydrogen carrier to the case portion, a screw conveyor disposed in the case portion and including a spiral blade for conveying the hydrogen carrier supplied from the hydrogen carrier supply portion, a liquid supply portion configured to supply a liquid containing water to the hydrogen carrier conveyed by the screw conveyor, and a hydrogen collection portion configured to collect hydrogen generated by a reaction between the hydrogen carrier and the liquid on the screw conveyor.

According to a second aspect of the present disclosure, a reaction case is configured to generate hydrogen by reacting a solid hydrogen carrier with a liquid containing water, and includes a case portion provided with a first supply port for supplying the hydrogen carrier, a second supply port for supplying the liquid, and a collection port for collecting the hydrogen generated by a reaction between the hydrogen carrier and the liquid, and a screw conveyor disposed in the case portion and including a spiral blade for conveying the hydrogen carrier supplied from the first supply port and reacting the conveyed hydrogen carrier with the liquid supplied from the second supply port.

Features of the present disclosure will become apparent from the following description of embodiments with reference to the attached drawings.

### BRIEF DESCRIPTION OF THE DRAWINGS

FIG. 1 is a conceptual diagram of a hydrogen generation apparatus according to an embodiment.

FIG. 2 is a schematic configurational perspective view of a hydrogen generation portion according to the embodiment.

FIG. 3 is a schematic configurational perspective view of a reaction case according to a first different example of the embodiment.

FIG. 4 is a schematic configurational perspective view of a reaction case according to a second different example of the embodiment.

FIG. 5 is a schematic configurational perspective view illustrating an initial state of a hydrogen carrier storage case according to the embodiment.

FIG. 6 is a schematic configurational perspective view illustrating a state in which a hydrogen carrier has been used up in the hydrogen carrier storage case according to the embodiment.

FIG. 7 is a schematic view of a temperature adjusting portion according to the embodiment.

FIG. 8 is a schematic configurational perspective view of another example of the hydrogen generation portion according to the embodiment.

### DESCRIPTION OF THE EMBODIMENTS

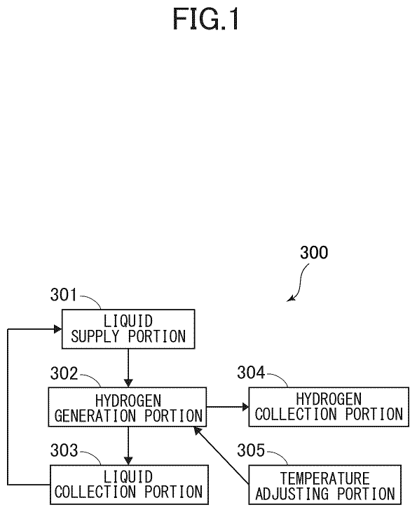

An embodiment will be described with reference to FIGS. 1 to 8. First, hydrogen is attracting attention as an energy source to replace fossil fuel. This is because, unlike fossil fuel, when being combusted, hydrogen does not generate, for example, carbon dioxide that is a kind of a greenhouse gas that causes global warming. One example of a system that uses hydrogen as an energy source and that is put into practical use is a fuel cell vehicle. A fuel cell vehicle is an automobile that generates power by using hydrogen as a raw material and moves by driving an electric motor by the generated power. Most of fuel cell vehicles store hydrogen serving as an energy source in a hydrogen tank, and generates power by charging the hydrogen discharged from the hydrogen tank into a fuel cell. In the hydrogen tank, hydrogen is stored in a compressed state at a high pressure such as 70 MPa (700 times as high as atmospheric pressure).

Hydrogen serving as an energy source has a problem that the energy density thereof is low. The volume energy density of hydrogen is about 1/3000 of that of gasoline, and energy of only about ⅕ of that of gasoline of the same volume can be obtained even if the hydrogen tank of 70 MPa is used. Therefore, typically, a fuel cell vehicle including a hydrogen tank is required to be charged with energy more frequently than an automobile using gasoline.

Therefore, as a material (that is, a hydrogen carrier) that can carry hydrogen at a higher energy density than a hydrogen tank, various materials are considered. For example, ammonia, methylcyclohexane, and the like are known as hydrogen carriers, and transporting a hydrogen carrier instead of hydrogen itself and taking out hydrogen from the hydrogen carrier at use are performed.

Among hydrogen carrier materials like these, metal hydrides such as sodium borohydride from which hydrogen can be easily taken out by pouring water thereon are widely known. As a method of obtaining hydrogen by hydrolysis of sodium borohydride, a method of dissolving sodium borohydride in water and using it as an aqueous solution is known. However, in the case of this method, there is a problem that more water than an amount required in the theory represented by the reaction formula is required, and thus the substantial volume energy density is reduced.

Therefore, in the present embodiment, hydrogen is generated by pouring a water-containing liquid on a solid hydrogen carrier by a hydrogen generation apparatus configured as described below. In addition, a byproduct generated by the reaction between the hydrogen carrier and the liquid is collected. The byproduct can be restored into the hydrogen carrier.

### [Hydrogen Generation Apparatus]

A schematic configuration of a hydrogen generation apparatus 300 will be described by using FIG. 1. The hydrogen generation apparatus 300 of the present embodiment includes a liquid supply portion 301, a hydrogen generation portion 302, a liquid collection portion 303, a hydrogen collection portion 304, and a temperature adjusting portion 305. The liquid supply portion 301 is a portion that supplies a water-containing liquid to the hydrogen generation portion 302, and is constituted by a tank and the like. The liquid collection portion 303 collects the water-containing liquid output from the hydrogen generation portion 302, removes a foreign matter by a filter, and returns the liquid to the liquid supply portion 301. The hydrogen collection portion 304 removes water vapor from a gas output from the hydrogen generation portion 302 by using silica gel or the like such that only hydrogen remains, and supplies the hydrogen to the outside of the apparatus. The temperature adjusting portion 305 adjusts the temperature of the hydrogen generation portion 302 by, for example, causing a cooling water to flow in the hydrogen generation portion 302. The hydrogen generation portion 302 is, as will be described in detail later, a portion that generates hydrogen by reacting a solid hydrogen carrier with the water-containing liquid. First, the hydrogen carrier and the water-containing liquid will be described.

### [Hydrogen Carrier]

The “hydrogen carrier” mentioned in the present embodiment is not particularly limited as long as the hydrogen carrier is a solid hydrogen carrier that generates hydrogen when a water-containing liquid is poured thereon. For example, solid metal hydrides such as sodium borohydride, potassium borohydride, lithium borohydride, zinc borohydride, aluminum lithium hydride, aluminum sodium hydride, aluminum magnesium hydride, aluminum calcium hydride, magnesium hydride, lithium hydride, sodium hydride, and calcium hydride, and metal powder such as aluminum, zinc, calcium, and magnesium can be used solely or in combination. In addition, an additive such as a reaction accelerator or a desiccant may be contained.

In addition, although the hydrogen carrier of the present embodiment is preferably a solid such as powder or granule, but solids such as sheets, pellets, and pastes are also usable. As the powder, one having a particle diameter of about 10 μm or more and 10 mm or less, and one having a particle diameter of 10 μm or more and 3 mm or less, and further one having a particle diameter of 10 μm or more and 100 μm or less are more preferable. In addition, in the case of use in the form of a sheet or a pellet, it is preferable to perform surface roughening, pore-forming treatment, or the like to increase the surface area and increase the contact area with the water-containing liquid from the viewpoint of enhancing the reactivity with the water-containing liquid.

In the present embodiment, a powder of sodium borohydride having an average particle diameter of 50 μm is used as the solid hydrogen carrier. To be noted, the average particle diameter of the solid hydrogen carrier is not limited to this. The sodium borohydride powder reacts with water to generate hydrogen. The reacted sodium borohydride turns into a powder of sodium metaborate that is a byproduct. This reaction is expressed as follows by a chemical formula.

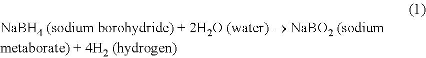

This reaction (chemical formula (1)) is known to be promoted by a Raney catalyst formed from metal such as nickel, cobalt, or copper, and an acidic solution such as citric acid or acetic acid. That is, the hydrogen carrier does not need to be constituted by a single substance, and may contain a substance having a different role such as a catalyst. For example, the hydrogen carrier may be constituted by a mixture of a powder of sodium borohydride serving as a source to generate hydrogen and a powder of Raney nickel serving as a catalyst, and in this case, sodium borohydride reacts with the liquid to generate hydrogen, and the Raney nickel does not change between before and after the reaction.

### [Water-Containing Liquid]

The “water-containing liquid” mentioned in the present embodiment is not particularly limited as long as the liquid reacts with the hydrogen carrier and generates hydrogen when poured. That is, the water-containing liquid may be a simple of water. In addition, two or more kinds of water-containing liquids may be prepared. By preparing two or more kinds of water-containing liquids, the generation speed of hydrogen can be adjusted.

The water-containing liquid can include a water-soluble organic solvent. Examples thereof can include alcohols, polyalkylene glycols, glycol ethers, nitrogen-containing compounds, and sulfur-containing compounds. Two kinds or more selected from these can be also used in mixture. By containing a water-soluble organic solvent, adjustment of the surface tension, adjustment of the boiling point and melting point of the water-containing liquid can be performed to optimize the reaction with the hydrogen carrier.

A surfactant can be added to the water-containing liquid. By using the surfactant, the surface tension of the water-containing liquid can be reduced, the contact area with the hydrogen carrier can be increased, and thus efficient reaction can be performed.

The water-containing liquid can contain a water-soluble acidic substance. The acidic substance functions as a positive catalyst in the reaction between the water-containing liquid and the hydrogen carrier. By adjusting the amount of the liquid containing the acidic substance, the generation speed of hydrogen can be adjusted. Particularly, by setting the pH obtained by the water-containing liquid and the hydrogen carrier to be lower than 9.0, the hydrogen generation speed can be increased. Examples thereof include various acids such as chloric acid, sulfuric acid, nitric acid, boric acid, and organic acids, but are not limited to these.

The water-containing liquid can include a water-soluble basic substance. The basic substance functions as a negative catalyst in the reaction between the water-containing liquid and the hydrogen carrier. By adjusting the amount of the liquid containing the basic substance, the generation speed of hydrogen can be adjusted. Particularly, by setting the pH obtained by the water-containing liquid and the hydrogen carrier to be equal to or higher than 9.0, the hydrogen generation speed can be reduced. Examples thereof include bases such as sodium hydrate, potassium hydrate, and ammonia water, but are not limited to these.

The water-containing liquid can include a buffer liquid. The buffer liquid functions to suppress pH fluctuation in the reaction between the water-containing liquid and the hydrogen carrier. By adjusting the amount of the liquid containing the buffer liquid, the generation speed of hydrogen can be adjusted. Examples thereof include various buffer liquids such as a phosphoric acid buffer liquid, a glycine buffer liquid, a Good's buffer liquid, a Tris buffer liquid, and an ammonia buffer liquid, but are not limited to these.

The water-containing liquid may contain various additives such as a defoaming agent, a pH adjuster, a viscosity adjuster, a rust inhibitor, an antiseptic agent, an antifungal agent, an antioxidant, and an anti-reduction agent in addition to the components described above if necessary.

### [Hydrogen Generation Portion]

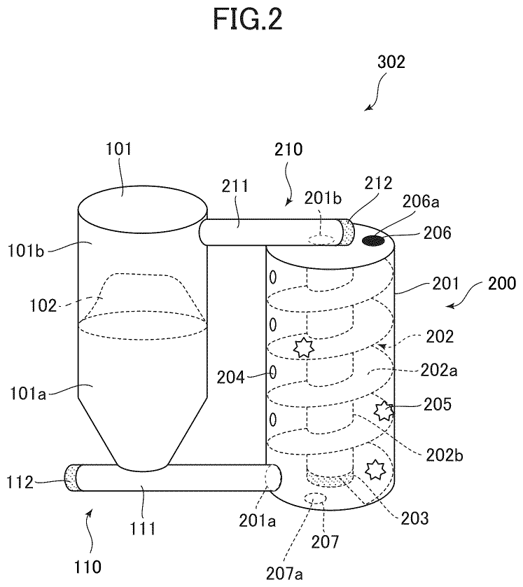

Next, the hydrogen generation portion 302 of the present embodiment will be described by using FIGS. 2 to 7. The hydrogen generation portion 302 includes a hydrogen carrier storage case 101, a reaction case 200, and the like. Further, hydrogen is generated in the reaction case 200 by supplying the solid hydrogen carrier from the hydrogen carrier storage case 101 into the reaction case 200 and supplying the water-containing liquid from the liquid supply portion 301 into the reaction case 200. Details will be described below.

As illustrated in FIG. 2, the hydrogen generation portion 302 includes the hydrogen carrier storage case 101 serving as a cartridge, the hydrogen carrier supply portion 110, the reaction case 200, and a byproduct collection portion 210. The reaction case 200 is a case for generating hydrogen by reacting the solid hydrogen carrier with the water-containing liquid, and includes a case portion 201 and a screw conveyor 202. Further, as will be described in detail later, the reaction case 200 generates hydrogen by, in the case portion 201, reacting the hydrogen carrier with the water-containing liquid on the screw conveyor 202 while conveying the hydrogen carrier by the screw conveyor 202. In addition, in the reaction case 200, the byproduct generated by the reaction is conveyed to the screw conveyor 202 as it is.

The hydrogen carrier storage case 101 includes a hydrogen carrier storage portion 101a, a byproduct accumulating portion 101b, and a separation film 102 serving as a partition member. The hydrogen carrier storage portion 101a is a portion that stores the hydrogen carrier to be supplied to the case portion 201 by the hydrogen carrier supply portion 110. The byproduct accumulating portion 101b is a portion for accumulating the byproduct collected by the byproduct collection portion 210. The separation film 102 partitions the hydrogen carrier storage portion 101a and the byproduct accumulating portion 101b from each other. The hydrogen carrier storage case 101 is attachable to and detachable from the case portion 201. That is, the hydrogen carrier storage case 101 is a replaceable cartridge.

The hydrogen carrier supply portion 110 is a portion that supplies the solid hydrogen carrier to the case portion 201. The hydrogen carrier supply portion 110 connects the hydrogen carrier storage portion 101a of the hydrogen carrier storage case 101 and the case portion 201 to each other, and supplies the hydrogen carrier storage portion 101a into the case portion 201.

The byproduct collection portion 210 is a portion that collects the byproduct generated by the reaction between the hydrogen carrier and the liquid on the screw conveyor 202 and conveyed by the screw conveyor 202. The byproduct collection portion 210 connects the byproduct accumulating portion 101b of the hydrogen carrier storage case 101 and the case portion 201 to each other, and supplies the hydrogen carrier from the case portion 201 to the byproduct accumulating portion 101b. Each element will be described in detail below.

### [Reaction Case]

The reaction case 200 includes the case portion 201 and the screw conveyor 202 as described above. The case portion 201 is formed in an approximate cylindrical shape, and is provided with a first supply port 201a for supplying the hydrogen carrier, second supply ports 204 for supplying the water-containing liquid, and a first collection port 206 for collecting the hydrogen generated by the reaction between the hydrogen carrier and the liquid.

In the present embodiment, the case portion 201 is disposed such that the center axis of the cylinder is in the vertical direction as illustrated in FIG. 2, and the first supply port (hydrogen supply port) 201a through which the hydrogen carrier is supplied is formed on the lower end side in the vertical direction. In addition, the first collection port 206 for collecting the hydrogen generated in the case portion 201 is formed in an upper end surface of the case portion 201. The first collection port (hydrogen collection port) 206 corresponds to a first connecting port connected to the hydrogen collection portion 304. The first collection port 206 is provided with a breathable lid 206a having breathability to allow a gas to pass therethrough but not allow a solid (powder in the present embodiment) to pass therethrough. The breathable lid 206a is formed from, for example, porous ceramics, and the hydrogen generated in the case portion 201 is supplied to the hydrogen collection portion 304 through the breathable lid 206a.

In addition, a plurality of second supply ports (liquid supply ports) 204 are formed in a side surface of the case portion 201 to be arranged in the vertical direction in the present embodiment. The second supply ports 204 are connected to the liquid supply portion 301, and supply the liquid supplied from the liquid supply portion 301 into the case portion 201. The second supply ports 204 are formed as a plurality of ports opening in an outer wall of the case portion 201 in the configuration illustrated in FIG. 2, but the configuration is not limited to this, and the second supply ports 204 may be configured in any form as long as the form allows the liquid to be supplied into the case portion 201.

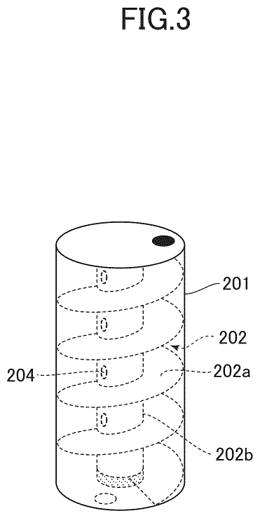

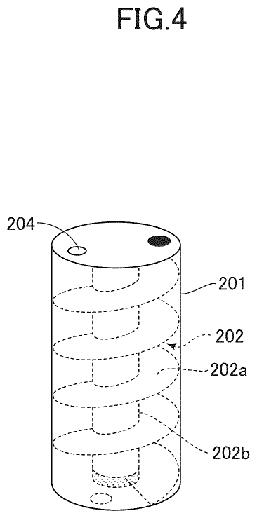

For example, as a first different example illustrated in FIG. 3, the rotation shaft 202b of the screw conveyor 202 may have the second supply ports 204. In FIG. 3, the liquid supply portion 301 is connected to the inside of the rotation shaft 202b, and a plurality of second supply ports 204 are formed in the outer peripheral surface of the rotation shaft 202b. In addition, as in a second different example illustrated in FIG. 4, one second supply port 204 may be provided in an upper portion of the case portion 201.

In addition, in the case portion 201, a second collection port 201b for collecting the byproduct generated by the reaction between the hydrogen carrier and the liquid is formed. The second collection port (byproduct collection port) 201b is formed on the upper end portion side in the vertical direction. Further, a discharge port 207 for discharging the liquid remaining without being used for the reaction is formed in the case portion 201. The discharge port (liquid discharge port) 207 corresponds to a second connecting port connected to the liquid collection portion 303, and the liquid discharged from the discharge port 207 is collected by the liquid collection portion 303. The discharge port 207 is formed to open in the lower end surface of the case portion 201.

The liquid supplied from the first supply port 201a into the case portion 201 flows on the screw conveyor 202 from the upper side to the lower side, and causes the reaction of the chemical formula (1) described above in the course of this. Sodium metaborate and hydrogen are generated in this reaction, and the liquid remaining without being used for the reaction accumulates in a lower portion of the case portion 201. Therefore, the discharge port 207 described above is formed in the lower portion of the case portion 201. The discharge port 207 is provided with a liquid-permeable lid 207a having liquid permeability to allow a liquid to pass therethrough and not allow a solid to pass there through. The liquid-permeable lid 207a is formed from, for example, porous ceramics, and the liquid accumulated in the lower portion of the case portion 201 is gradually supplied to the liquid collection portion 303 through the liquid-permeable lid 207a. The liquid collected by the liquid collection portion 303 is sent to the liquid supply portion 301 as described above, and is supplied into the case portion 201 again through the second supply ports 204.

The screw conveyor 202 is disposed in the case portion, and includes a spiral blade 202a for conveying the hydrogen supplied from the first supply port 201a and reacting the conveyed hydrogen carrier with the liquid supplied from the second supply ports 204. That is, the screw conveyor 202 includes the rotation shaft 202b and the blade 202a provided in a spiral shape around the rotation shaft 202b. In the present embodiment, the screw conveyor 202 is disposed such that the rotation shaft 202b is approximately parallel to the vertical direction, and is configured to convey the hydrogen carrier from the lower side to the upper side.

The rotation shaft 202b is disposed on the center axis of the cylindrical case portion 201. In addition, the blade 202a provided around the rotation shaft 202b is disposed such that the outer peripheral edge portion thereof is near the inner peripheral surface of the case portion 201. The rotation shaft 202b is connected to the motor 203 serving as a driving portion, and the screw conveyor 202 rotates in the clockwise direction as viewed from above by being driven by a motor 203.

In addition, in the present embodiment, a catalyst substance 205 for promoting the reaction between the hydrogen carrier and the liquid is movably disposed on the surface of the blade 202a of the screw conveyor 202 that conveys the hydrogen carrier. The catalyst substance 205 is configured as a sphere having a Konpeito-like shape provided with a plurality of spikes, and the surface thereof is coated by a catalyst substance such as Raney nickel. In addition, the surface of the blade 202a may be also coated by a catalyst substance.

### [Hydrogen Carrier Storage Case]

The hydrogen carrier storage case 101 stores the hydrogen carrier and accumulates the byproduct as described above. The hydrogen carrier storage case 101 may be formed from any material as long as the material can store the powder without leakage, and is formed from, for example, resin. In the present embodiment, the hydrogen carrier storage case 101 stores a powder of sodium borohydride as the hydrogen carrier, and accumulates a powder of sodium metaborate as the byproduct after the reaction. The hydrogen carrier storage case 101 can be separated from the hydrogen generation apparatus 300 and carry sodium borohydride serving as fuel. In addition, sodium metaborate powder after all the sodium borohydride is used up can be stored, and thus sodium metaborate serving as waste can be carried.

The separation film 102 dividing the inner region is provided in the hydrogen carrier storage case 101. The separation film 102 has a role to divide the inside of the hydrogen carrier storage case 101 into two regions such that powders stored in respective regions are not mixed together. That is, the separation film 102 partitions the inside of the hydrogen carrier storage case 101 into the hydrogen carrier storage portion 101a and the byproduct accumulating portion 101b as described above.

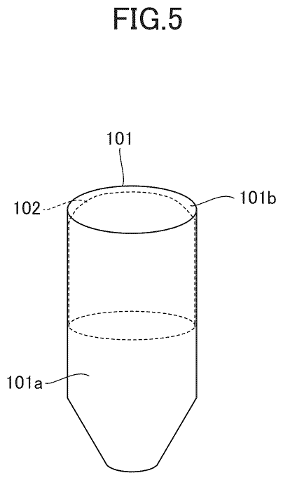

The separation film 102 configured in this manner is formed from a soft and elastic material, and is capable of changing the volume of each of the hydrogen carrier storage portion 101a and the byproduct accumulating portion 101b. That is, in the initial state of the hydrogen carrier storage case 101, that is, a state in which the inside thereof is filled with the hydrogen carrier and no byproduct is accumulated therein, the separation film 102 extends to the vicinity of an upper portion of the hydrogen carrier storage case 101 as illustrated in FIG. 5. In this state, the volume of the hydrogen carrier storage portion 101a is sufficiently larger than the volume of the byproduct accumulating portion 101b, and a lot of hydrogen carrier can be stored in the hydrogen carrier storage portion 101a.

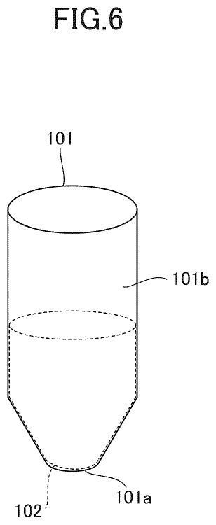

Meanwhile, in the case where the hydrogen carrier is used and the byproduct generated by the hydrogen generation reaction in the hydrogen generation apparatus 300 starts accumulating in the byproduct accumulating portion 101b, the hydrogen carrier in the hydrogen carrier storage portion 101a starts decreasing, and the byproduct in the byproduct accumulating portion 101b starts increasing. In this case, since the byproduct accumulates at the upper surface of the separation film 102, the separation film 102 is stretched downward by the weight thereof. In this case, the volume of the hydrogen carrier storage portion 101a gradually decreases, the volume of the byproduct accumulating portion 101b gradually increases, and thus more byproduct can be accumulated in the byproduct accumulating portion 101b. Further, as illustrated in FIG. 6, when the hydrogen carrier on the inside is used up, the separation film 102 is stretched to the vicinity of the lower portion of the case portion 201, the volume of the byproduct accumulating portion 101b is sufficiently larger than the volume of the hydrogen carrier storage portion 101a, and a lot of byproduct is accumulated in the byproduct accumulating portion 101b. In this state, since only the byproduct is stored in the hydrogen carrier storage case 101, the hydrogen carrier storage case 101 is replaced.

To be noted, although it is assumed that the hydrogen carrier storage case 101 stores both sodium borohydride and sodium metaborate, sodium borohydride and sodium metaborate may be each stored in a different cartridge.

### [Hydrogen Carrier Supply Portion]

As illustrated in FIG. 2, the hydrogen carrier supply portion 110 includes a powder transport pipe 111, a screw (illustration omitted) disposed in the powder transport pipe 111, and a motor 112 serving as a driving portion that drives the screw. The powder transport pipe 111 is connected to the lower portion of the hydrogen carrier storage case 101, and the hydrogen carrier is supplied into the powder transport pipe 111 by gravity from the hydrogen carrier storage portion 101a storing the hydrogen carrier. The downstream end portion of the powder transport pipe 111 in the conveyance direction of the powder is connected to the first supply port 201a of the case portion 201.

The hydrogen carrier supply portion 110 configured in this manner conveys the hydrogen carrier powder supplied from the hydrogen carrier storage portion 101a to the powder transport pipe 111 to the first supply port 201a, by rotating the screw by the motor 112. As a result of this, the hydrogen carrier is transported from the hydrogen carrier storage case 101 into the case portion 201.

### [Byproduct Collection Portion]

As illustrated in FIG. 2, the byproduct collection portion 210 includes a powder transport pipe 211, a screw (illustration omitted) disposed in the powder transport pipe 211, and a motor 212 serving as a driving portion that drives the screw. The upstream end portion of the powder transport pipe 211 in the conveyance direction of the powder is connected to the second collection port 201b of the case portion 201. The byproduct generated in the case portion 201 is conveyed upward by the screw conveyor 202, and is sent to the upstream end portion of the powder transport pipe 211 through the second collection port 201b. The downstream end portion of the powder transport pipe 211 in the conveyance direction of the powder is connected to the upper portion of the hydrogen carrier storage case 101. The byproduct conveyed in the powder transport pipe 211 is supplied to the byproduct accumulating portion 101b accumulating the byproduct.

The byproduct collection portion 210 conveys the hydrogen carrier powder, which is supplied from the case portion 201 to the powder transport pipe 211 through the second collection port 201b, to the byproduct accumulating portion 101b of the hydrogen carrier storage case 101 by rotating the screw by the motor 212. As a result of this, the byproduct is transported from the case portion 201 to the hydrogen carrier storage case 101.

### [Temperature Adjusting Portion]

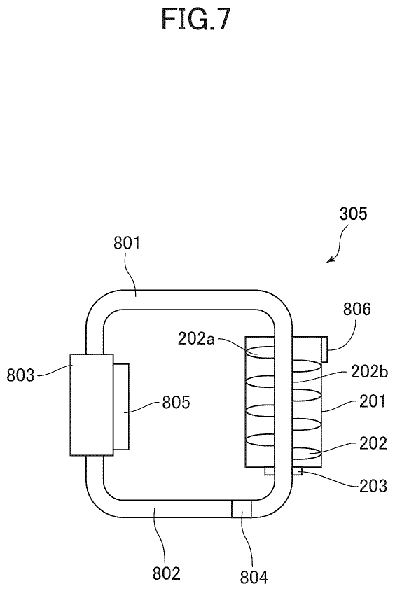

The detailed configuration of the temperature adjusting portion 305 described with reference to FIG. 1 will be described by using FIG. 7. Here, the reaction of the chemical formula (1) is a heat generating reaction. Therefore, the temperature in the case portion 201 increases as the reaction progresses. The temperature adjusting portion 305 is provided to suppress this, and adjusts the temperature in the case portion within a predetermined temperature range (for example, a temperature range set in a range higher than 0° C. and equal to or lower than 80° C.).

The temperature adjusting portion 305 includes a first pipe 801, a second pipe 802, a radiator 803 serving as a heat exchanger, a pump 804, a fan 805, and a temperature sensor 806. The first pipe 801 is a pipe for interconnecting the radiator 803 and the rotation shaft 202b of the screw conveyor 202 and supplying a heat medium such as water from the radiator 803 to the rotation shaft 202b. The second pipe 802 is a pipe for interconnecting the rotation shaft 202b and the radiator 803 and collecting the heat medium having passed the rotation shaft 202b. The first pipe 801 and the second pipe 802 are integrated with or connected to each other, and are disposed to penetrate the rotation shaft 202b and the motor 203.

The radiator 803 performs heat exchange between the heat medium sent from the second pipe 802 and the air therearound, and sends the heat medium subjected to heat exchange to the first pipe 801. The pump 804 sucks in and discharges the heat medium such that the heat medium flows in the first pipe 801, the second pipe 802, and the radiator 803, and is provided in the second pipe 802 in the present embodiment. The pump may be provided in any position in the flow path of the heat medium, and may be provided in the first pipe 801.

The fan 805 is provided for sending air to the radiator 803. The temperature sensor 806 is provided in the case portion 201, and detects the temperature of the inside or the outside of the case portion 201. When the temperature sensor 806 reaches a preset lower limit temperature, an unillustrated controller drives the pump 804 and thus causes the heat medium to flow in one direction in a path constituted by the first pipe 801, the second pipe 802, and the radiator 803. At this time, the fan 805 is also driven. The heat medium obtains heat in the case portion 201, the obtained heat is cooled down by the radiator 803, and the radiator 803 is cooled down by the fan 805. Then, the controller stops the driving of the pump 804 and the fan 805 when the temperature sensor 806 reaches the predetermined temperature that is set in advance. As a result of this, the temperature in the case portion 201 is adjusted within a predetermined temperature range.

### [Operation of Hydrogen Generation Apparatus]

The operation of the hydrogen generation apparatus 300 configured as described above will be described. The unillustrated controller drives the motor 112 of the hydrogen carrier supply portion 110, and thus supplies the hydrogen carrier from the hydrogen carrier storage case 101 to the first supply port 201a provided at a lower portion of the reaction case 200 through the powder transport pipe 111. The hydrogen carrier supplied to the first supply port 201a is gradually conveyed upward from the lower portion by the screw conveyor 202 driven by the motor 203. In parallel with this, the water-containing liquid is supplied from the liquid supply portion 301 to the second supply ports 204 of the reaction case 200. Then, in the case portion 201, the hydrogen carrier conveyed by the screw conveyor 202 and the liquid supplied from the second supply port 204 react, and a hydrogen gas and a byproduct powder are generated.

In the case where the hydrogen carrier is sodium borohydride, sodium borohydride moving upward on the screw conveyor 202 moves upward while turning into sodium metaborate by reacting with the liquid supplied from the second supply ports 204. The concentration of sodium metaborate increases as the sodium borohydride supplied from the lowermost portion of the case portion 201 moves upward in the case portion 201, and, at the uppermost portion, all is sodium metaborate.

In addition, the hydrogen carrier is conveyed by the upper surface of the blade 202a of the screw conveyor 202, and since the catalyst substance 205 is present on the upper surface of the blade 202a, this reaction is promoted. The plurality of catalyst substances 205 having spherical shapes exhibit the catalytic function of promoting the reaction of the chemical formula (1) while freely moving on the upper surface of the blade 202a.

The hydrogen generated in the case portion 201 is collected by the hydrogen collection portion 304 through the first collection port 206 provided in an upper portion of the case portion 201. Meanwhile, the byproduct generated together with the hydrogen is conveyed upward by the screw conveyor 202, and is sent to the powder transport pipe 211 of the byproduct collection portion 210 through the second collection port 201b provided in an upper portion of the case portion 201. The byproduct supplied to the powder transport pipe 211 is sent to the hydrogen carrier storage case 101 by the screw rotated by being driven by the motor 203, and is accumulated in the byproduct accumulating portion 101b.

To be noted, the liquid supplied from the second supply ports 204 flows on the screw conveyor 202 from the upper side to the lower side, and causes the reaction of the chemical formula (1) in the course of that. The liquid remaining without being used for this reaction accumulates in the lower portion of the case portion 201, is then discharged from the discharge port 207 provided in the lower portion of the case portion 201, and is collected by the liquid collection portion 303.

This operation is repeated, and when the hydrogen carrier stored in the hydrogen carrier storage portion 101a of the hydrogen carrier storage case 101 is used up and the byproduct is accumulated in the byproduct accumulating portion 101b, the hydrogen carrier storage case 101 is replaced. The hydrogen carrier storage case 101 storing only the hydrogen carrier is newly connected to the hydrogen generation apparatus 300, and hydrogen is generated as described above.

In the case of the present embodiment configured in this manner, hydrogen is generated in the case portion 201 by supplying the liquid while gradually conveying the hydrogen carrier by the screw conveyor 202. Therefore, a hydrogen generation apparatus that easily promotes the reaction between the hydrogen carrier and the water-containing liquid can be provided.

For example, in the case where a configuration in which a spiral plate that does not rotate is provided instead of the screw conveyor 202 and the hydrogen carrier is moved by the gravity along the spiral plate is employed, there is a possibility that the hydrogen carrier powder remains on the spiral plate and hydrogen cannot be generated continuously. In contrast, in the present embodiment, since hydrogen is generated while conveying the hydrogen carrier by the screw conveyor 202, hydrogen can be generated continuously even though the hydrogen carrier is powder, and thus the reaction between the hydrogen carrier and the water-containing liquid can be easily promoted.

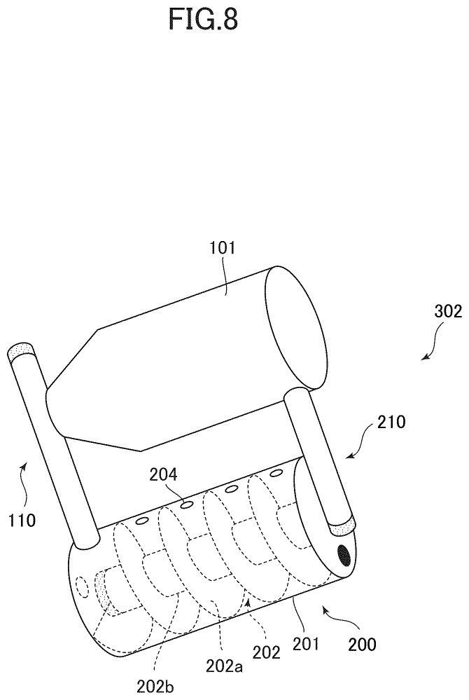

In addition, in the present embodiment, the hydrogen carrier is configured to be conveyed by the screw conveyor 202, and therefore the flexibility of the shape and layout of the apparatus is high as compared with a configuration in which the hydrogen carrier is moved on a spiral plate by gravity. For example, the hydrogen generation portion 302 can be disposed obliquely with respect to the gravity direction as shown in another example illustrated in FIG. 8. That is, in the description above, the hydrogen carrier storage case 101 is configured such that the byproduct is stored in the upper portion thereof, the hydrogen carrier is stored in the lower portion thereof, and the hydrogen carrier moves from the lower side to the upper side in the case portion 201. Therefore, the hydrogen carrier storage case 101, the case portion 201, and the screw conveyor 202 are arranged along the gravity direction.

However, the hydrogen generation apparatus 300 of the present embodiment is not limited to this form. For example, as in another example illustrated in FIG. 8, the hydrogen carrier storage case 101, the case portion 201, and the screw conveyor 202 may be arranged obliquely with respect to the gravity direction, and further, these may be arranged along the horizontal direction.

In addition, the powder transport pipes 111 and 211 interconnecting the hydrogen carrier storage case 101 and the case portion 201 are not limited to a linear shape, and may be configured to include a bent portion. Therefore, the positional relationship of the hydrogen carrier storage case 101 and the case portion 201 in the up-down direction is not limited to the relationship described above, and may be flipped vertically.

In addition, in the present embodiment, the merit of conveying the hydrogen carrier by the screw conveyor 202 is that the hydrogen carrier powder moves spirally in the case portion 201, and therefore a long path can be secured as a path for reaction between the hydrogen carrier and the liquid. In addition, the screw conveyor 202 has a nature to stir the conveyed matter, and the reaction between the hydrogen carrier and the liquid is promoted by this nature.

In addition, in the present embodiment, the merit of storing the byproduct and the hydrogen carrier in the upper portion and the lower portion of the hydrogen carrier storage case 101, respectively, is that gravity can be used for charging the byproduct and discharging the hydrogen carrier, the powder is less likely to clog the path as a result, and the energy consumption can be reduced.

In addition, in the present embodiment, as described above, since the hydrogen carrier storage case 101 can be detached from the apparatus body, in the case where the hydrogen carrier therein is used up, hydrogen can be newly taken out by performing replacement with another hydrogen carrier storage case 101. The detached hydrogen carrier storage case 101 can be used as a container for carrying the byproduct, and for example, sodium metaborate can be restored into sodium borohydride and newly charged into the hydrogen carrier storage case 101.

Further, in the present embodiment, the generation speed of hydrogen can be controlled by changing the operation of the various motors and the supply amount of the liquid. The motors 112, 203, and 212 can be each independently controlled, and, for example, control may be performed such that the motors 203 and 212 are driven until no powder remains in the case portion 201 while the driving of the motor 112 is stopped, and then the motors 203 and 212 are stopped.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A hydrogen generation apparatus comprising:
a case portion;
a hydrogen carrier supply portion configured to supply a solid hydrogen carrier to the case portion;
a screw conveyor disposed in the case portion and including a spiral blade for conveying the hydrogen carrier supplied from the hydrogen carrier supply portion;
a liquid supply portion configured to supply a liquid containing water to the hydrogen carrier conveyed by the screw conveyor; and
a hydrogen collection portion configured to collect hydrogen generated by a reaction between the hydrogen carrier and the liquid on the screw conveyor.

2. The hydrogen generation apparatus according to claim 1, wherein the screw conveyor configured to convey the hydrogen carrier from a lower side to an upper side.

3. The hydrogen generation apparatus according to claim 1, wherein a catalyst substance for promoting the reaction between the hydrogen carrier and the liquid is movably disposed on a surface of the blade conveying the hydrogen carrier.

4. The hydrogen generation apparatus according to claim 1, wherein a surface of the blade conveying the hydrogen carrier is coated by a catalyst substance for promoting the reaction between the hydrogen carrier and the liquid.

5. The hydrogen generation apparatus according to claim 1, wherein the case portion has a plurality of supply ports for supplying the liquid supplied from the liquid supply portion into the case portion.

6. The hydrogen generation apparatus according to claim 1,
wherein the screw conveyor includes a rotation shaft on which the blade is provided, and
wherein the rotation shaft has a supply port for supplying the liquid supplied from the liquid supply portion into the case portion.

7. The hydrogen generation apparatus according to claim 1,
wherein the case portion has a first connecting port connected to the hydrogen collection portion, and
wherein the first connecting port is provided with a breathable lid having breathability to allow a gas to pass therethrough but not allow a solid to pass therethrough.

8. The hydrogen generation apparatus according to claim 1, further comprising:
a liquid collection portion configured to collect the liquid from the case portion,
wherein the case portion has a second connecting port connected to the liquid collection portion, and
wherein the second connecting port is provided with a liquid-permeable lid having liquid permeability to allow a liquid to pass therethrough but not allow a solid to pass therethrough.

9. The hydrogen generation apparatus according to claim 8, wherein the liquid collection portion configured to supply the liquid which has been collected from the case portion and from which foreign matter has been removed to the liquid supply portion.

10. The hydrogen generation apparatus according to claim 1, further comprising:
a hydrogen carrier storage case configured to store the hydrogen carrier to be supplied by the hydrogen carrier supply portion to the case portion,
wherein the hydrogen carrier storage case is attachable to and detachable from the case portion.

11. The hydrogen generation apparatus according to claim 1, further comprising a byproduct collection portion configured to collect a byproduct generated by the reaction between the hydrogen carrier and the liquid on the screw conveyor and conveyed by the screw conveyor.

12. The hydrogen generation apparatus according to claim 11, further comprising:
a cartridge that is attachable to and detachable from the case portion and that includes
a hydrogen carrier storage portion configured to store the hydrogen carrier to be supplied to the case portion by the hydrogen carrier supply portion;
a byproduct accumulating portion configured to accumulate the byproduct collected by the byproduct collection portion; and
a partition member configured to partition the hydrogen carrier storage portion and the byproduct accumulating portion from each other,
wherein the partition member has elasticity and is capable of changing a volume of each of the hydrogen carrier storage portion and the byproduct accumulating portion.

13. The hydrogen generation apparatus according to claim 1, further comprising a temperature adjusting portion configured to adjust a temperature in the case portion to a predetermined temperature.

14. The hydrogen generation apparatus according to claim 13,
wherein the screw conveyor includes a rotation shaft provided with the blade, and
wherein the temperature adjusting portion includes
a first pipe for supplying a heat medium to the rotation shaft,
a second pipe for collecting the heat medium having passed the rotation shaft, and
a heat exchanger configured to perform heat exchange between the heat medium sent thereto through the second pipe and an air therearound and send the heat medium subjected to the heat exchange to the first pipe.

15. A reaction case configured to generate hydrogen by reacting a solid hydrogen carrier with a liquid containing water, the reaction case comprising:
a case portion provided with a first supply port for supplying the hydrogen carrier, a second supply port for supplying the liquid, and a collection port for collecting the hydrogen generated by a reaction between the hydrogen carrier and the liquid; and
a screw conveyor disposed in the case portion and including a spiral blade for conveying the hydrogen carrier supplied from the first supply port and reacting the conveyed hydrogen carrier with the liquid supplied from the second supply port.
